(19) United States
(12) Patent Application Publication
(10) Pub. No.: US 2012/0305538 A1
(43) Pub. Date: Dec. 6, 2012

(54) Condensation reduction system for aluminum windows

(76) Inventor: Thomas Lund, (US)

(21) Appl. No.: 13/507,048

(22) Filed: May 31, 2012

Related U.S. Application Data
(60) Provisional application No. 61/519,832, filed on May 31, 2011.

(51) Int. Cl. H05B 3/02

(52) U.S. Cl. 219/201

(57) ABSTRACT

A method and apparatus for reducing condensation on aluminum windows, especially those in high-rise apartment buildings. The method uses application of heat directly to the aluminum window frame via electric heating cables to eliminate disparate temperature conditions that lead to condensation. By applying the heat in the systematic way, allows for seamless application of the wiring that can be hidden by aluminum caps such that they would be undetectable. This allows the user of the device and method to eliminate the condensation problem without altering the structural condition of the window.

### RELATED PATENT APPLICATION

This application is a non-provisional patent application of provisional patent application, filed May 31, 2011, and having Ser. No. 61/519,832. Benefit of the May 31, 2011 date is hereby claimed.

### BACKGROUND OF THE INVENTION

Window condensation is a common problem in many high-rise buildings, especially those with aluminum windows, in the winter. During winter months, even relatively low humidity levels in a condominium or apartment can cause significant condensation on aluminum windows. Moderate humidity levels can create such condensation that the run-off of water from the windows can threaten woodwork and damage walls.

In winter, water molecules in the air will slow and condense when they make contact with cold surfaces such as window panes and aluminum window frames. Due to their metallic nature, aluminum frames conduct heat and cold effectively. When the frames become extremely cold, due to outside temperatures, they conduct those cold temperatures into the interior of the window. Once the frame becomes cold, the water molecules in the air inside the home begin to condense on the window and frame leading to water infiltration and water damage from the run-off.

The device and method provided herein provide a cost-effective, simple and discreet remedy to this problem. The device applies heat directly to various components of the window frame using an electric heating cable. The application of heat directly to the window frame components eliminates the disparate temperature conditions between the interior air and the window frame thereby reducing or eliminating window condensation.

Numerous devices and methods have been attempted and used to prevent condensation. U.S. Pat. No. 6,886,351 to Palfy discloses a device and method for sensing condensation conditions and for preventing and removing condensation from multiple surfaces. The device and method involve complicated and numerous parts and/or components. The device and method also mechanically and permanently affix to the surface or are embedded in the surface. While this may be suitable for some applications, such would not be acceptable in many high-rise buildings which prohibit such permanent affixations or embedment. The present device and method are easily attached and removed from any window to allow users to avoid damage to the windows.

### SUMMARY OF THE INVENTION

A condensation reduction system for aluminum windows is provided. The system consists of self-regulating electrical heating cables, industrial adhesive and a means for concealing the adhesion of the electrical heating cables to the aluminum window frame. The invention consists of attaching self-regulating electrical heating cables to a window using industrial adhesive and colored aluminum caps that conceal the cables and provide an appearance of unadulterated windows. The electrical heating cables convert either 120V or 240V electrical current into radiant heat. The industrial adhesive must be sufficiently strong to secure the cables to the window while being malleable enough to be removed easily and without marring the surface of the window. The means for concealment of the system generally consists of aluminum caps that are placed over the system and existing frame. While this means will generally be aluminum in nature, there is no requirement that it be; rather, the means can be of any general material used in construction.

The object of the present invention is to provide a device that eliminates or reduces condensation on aluminum windows. More specifically, the system is designed to be utilized and to be removable without damage to the structural components of the window. As such, the application of the self-regulating heating cables is performed by means of an industrial adhesive.

The method of installing the invention to the window consists of: (a) creating a electrical heating cable map to determine the path and length of each cable to be used on a window frame; (b) application of the adhesive to the window; (c) installation of the electric heating cables such that there is seamless, uniform installation of the cable that allows the colored aluminum caps to be installed concealing the placement of the electric heating cables; and (d) installation of the colored aluminum caps fitted to the size, shape and color of the window to conceal the placement of the electric heating cables.

The method of applying the electrical heating cables to the window will vary slightly depending on the size, shape and type of window. The electrical heating cables will ideally have an electrical output of eight watts per linear foot, and are usually run in multiple passes to achieve the necessary heat output necessary to control each window's condensation. Typically, a total output of 24 watts per linear foot is preferred.

### BRIEF DESCRIPTION OF THE DRAWINGS

FIG. 1 and FIG. 2 illustrate a window and blow-up of section of window frame and self-regulating heating cables attached with industrial adhesive and concealed with colored aluminum caps;

FIG. 3 illustrates flow diagram showing a heating cable map for a window system as provided.

### DETAILED DESCRIPTION OF THE PREFERRED EMBODIMENTS

A device and method for reducing or eliminating condensation on aluminum windows is provided. The device consists of three components, each of which have variability and preferred embodiments. The first component is industrial adhesive that affixes the electric heating cables to the window frame. The preferred adhesive to be used in installing the electric heating cables is a double-sided acrylic foam tape with viscoelastic properties. The adhesive may vary as long as it maintains the ability to adhere to both the window and the cable and be removed without damage to the window. The adhesive must also be able to withstand the extended heat provided by the electric heating cables and cold temperatures conducted through the window frame from the outside.

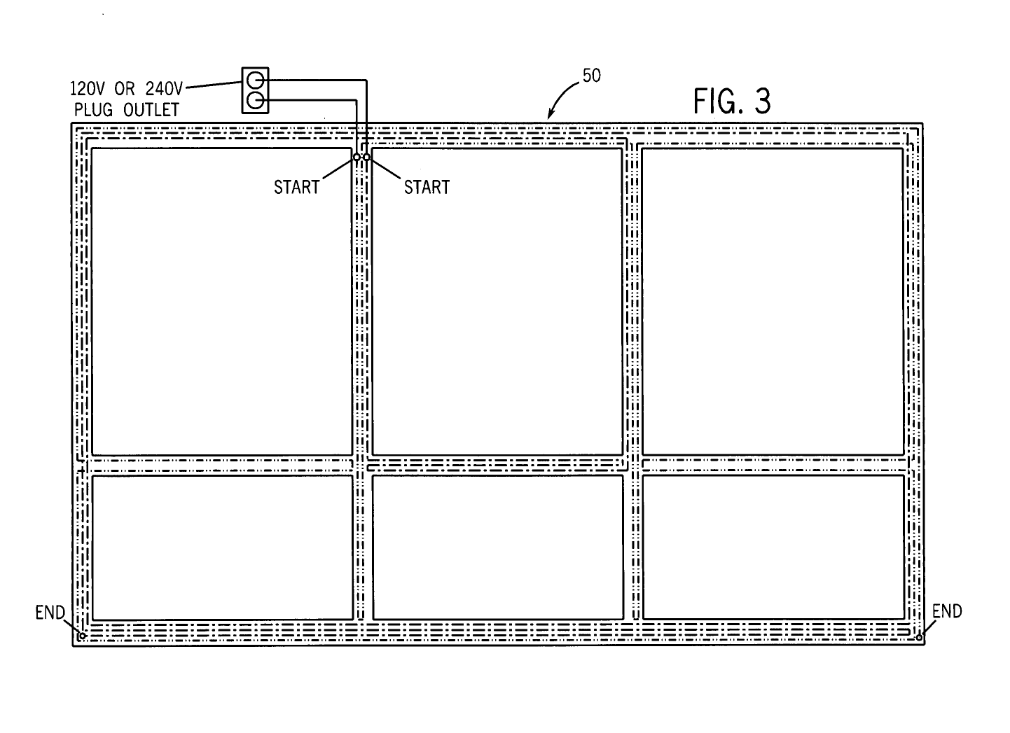

The second component is electric heating cables. The electrical heating cables used convert either 120 volt or 240 volt electrical current into radiant heat and can be plugged into a standard electrical outlet or hardwired into a junction box. A typical heating cable consists of bus wires surrounded by a conductive core that acts as a heat source and covered by one or more protective jackets. The jackets may be polyolefin and/or braided copper. The preferred embodiment of the electric heating cables is a thermostatically controlled heating cable that allows a user to set the cable to a specific temperature or a self-regulating heating cable that regulates according to the temperature of the window frame. The cables are configured on the window using a heat map as shown in FIG. 3. The preferred embodiment of the configuration utilizes an output of approximately eight watts per linear foot of cable. The cable is then arranged such that multiple passes of a cable are made to achieve an optimum overall output of watts per linear foot as required by the window. In the preferred embodiment, the optimum output is twenty-four watts per linear foot of window frame.

The third component is colored aluminum caps that mimic the aluminum frame such that their application conceals the other components. This component will by design vary according to each and every window such that it will conform to each window fitted with the invention. While this component will in most instances be aluminum such is not a requirement. The cap can be made of varying materials provided it conceals the original window frame and application of the condensation reduction system.

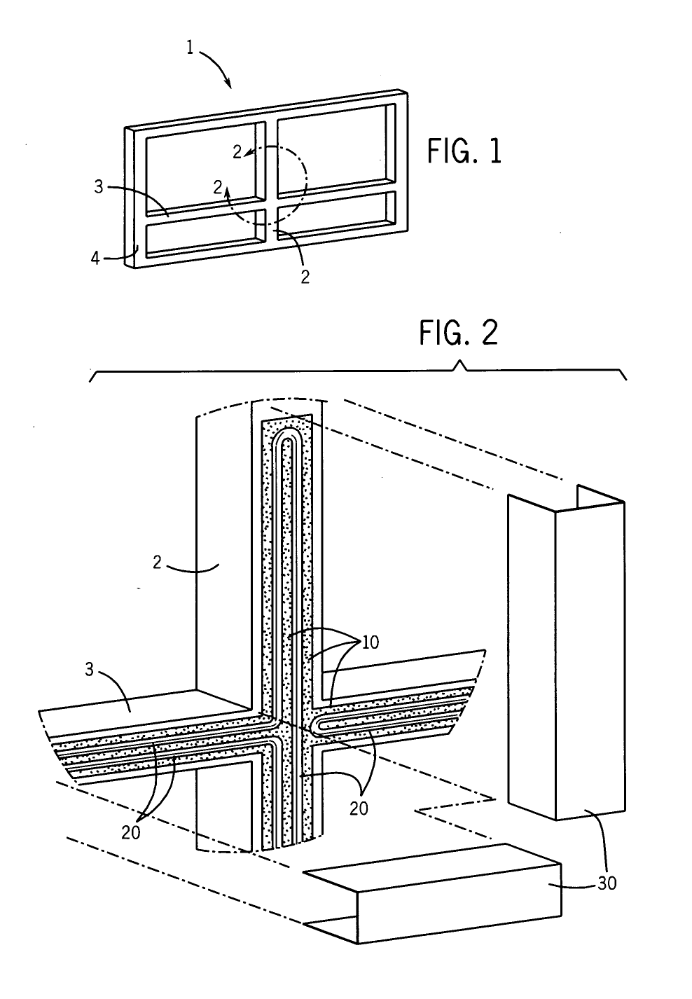

Referring now to the FIGS. 1 and 2, aluminum window frame with blow-up of invention installed on said frame. Window 1 consists of mullion 2, transom 3 and outside frame 4. Adhesive 10 is applied to all aluminum portions of Window 1 including mullion 2, transom 3, and frame 4. Electric heating cable 20 is then attached to the window parts using Adhesive 10 as configured in the Heat Map 50 as shown in FIG. 3. As discussed below, the preferred embodiment provides of an electrical output of eight watts per linear foot of cable and ideally twenty-four watts per linear foot of total electricity per foot of window frame. Aluminum cap 30 is installed over window frame 4, mullion 2 and transom 3 to conceal electric heating cable 20 and adhesive 10. Aluminum cap 30 will be fitted tightly to window frame 4 to ensure security and prevent detection of system.

Referring to FIG. 3, this provides method diagram of configuring and affixing the electric heating cables in such a pattern that uniformity of heat distribution occurs along the entire window frame. More specifically, the cables are to be laid out in such a path that an ideal output for each individual window can be achieved by affixing one or more lengths of cable, at eight watts per linear foot sections, until the desired output is achieved. The cables should also be applied in a manner that allows for concealment of the cables by the attachment of colored aluminum caps as specified.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A condensation reduction system for aluminum windows compromising:
an electrical heating cable map
means for adhering the cables to the window frame
electric heating cable
means for concealing the adhesive, electric heating cables.

2. A method for elimination of condensation on aluminum windows compromising the steps of:
a. creation of an electrical heating cable map that creates the necessary electrical output necessary to control condensation
b. applying a means for adhering the cables to the window frame
c. applying electric heating cable in accordance with the heat cable map
d. adhering a means for concealing the adhesive and electric heating cables.

3. The system of claim 1 in which the electrical cable used is 120 volt.

4. The system of claim 1 in which the electrical cable used is 240 volt.

5. The system of claim 1 in which the adhesive used is acrylic foam tape with viscoelastic properties.

6. The system of claim 1 in which the heating cable is self-regulating.

7. The system of claim 1 in which the heating cable is a thermostatically controlled heating cable.

8. The system of claim 1 in which the means for concealing the system is aluminum.

9. The system of claim 1 in which the means for concealing the system is wood.

10. The method of claim 2 in which the electrical cable used is 120 volt.

11. The method of claim 2 in which the electrical cable used is 240 volt.

12. The method of claim 2 in which the adhesive used is acrylic foam tape with viscoelastic properties.

13. The method of claim 2 in which the heating cable is self-regulating.

14. The method of claim 2 in which the heating cable is a thermostatically controlled heating cable.

15. The method of claim 2 in which the means for concealing the system is aluminum.

16. The method of claim 2 in which the means for concealing the system is wood.

17. The method of claim 2 where the electrical cables produce an output of eight watts per linear foot.

18. The method of claim 2 where the electrical cables are arranged by overlapping cables to produce an output of twenty-four watts per linear foot.
